(19) United States
(12) Patent Application Publication
(10) Pub. No.: US 2007/0127641 A1
(43) Pub. Date: Jun. 7, 2007

(54) Server apparatus

(75) Inventors: Yasumasa Sasaki, Tachikawa-shi (JP); Shigeru Fukazawa, Hachioji-shi (JP); Koji Shima, Sagamihara-shi (JP); Fumikazu Matsukawa, Ome-shi (JP); Nobuyuki Takeda, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/585,838

(22) Filed: Oct. 25, 2006

(30) Foreign Application Priority Data
Oct. 26, 2005 (JP) 2005-311601

(51) Int. Cl. H04M 11/00

(52) U.S. Cl. 379/88.13

(57) ABSTRACT

According to one embodiment, a server apparatus includes a memory which stores a management table in which the user IDs are caused to correspond to pieces of setting information representing functions/states of the data terminals, and a controller which updates the setting information of the corresponding first data terminal of said plurality of data terminals in the management table, in generation of an updating request of the setting information, and notifies a plurality of second data terminals different from the first data terminal of the updated setting information.

### CROSS-REFERENCE TO RELATED APPLICATIONS

This application is based upon and claims the benefit of priority from Japanese Patent Application No. 2005-311601, filed Oct. 26, 2005, the entire contents of which are incorporated herein by reference.

### BACKGROUND

1. Field

One embodiment of the invention relates to a server apparatus for a visual communication system in which the server apparatus is connected to, for example, a telephone switching device through a communication channel to make it possible to handle not only an audio signal but also a video signal, computer data, and the like.

2. Description of the Related Art

In offices or business institutions, in-house network systems are used. In the in-house network system, telephone sets are stored as internal terminals in a telephone exchange apparatus such as a private branch exchange (PBX) or a key telephone apparatus, and the internal terminals and an exchange communication network such as public network are switchably connected to each other by a telephone exchange apparatus, and the internal terminals are switchably connected to each other by the telephone exchange apparatus to make it possible perform telephone communication.

In recent years, the following system is also proposed. That is, a server to which a data terminal such as a television telephone terminal and a personal computer is connected is connected to a telephone exchange apparatus-through a transmission channel to cooperate an audio communication system using the telephone exchange apparatus and a data communication system using the server (for example, Jpn. Pat. Appln. KOKAI Publication No. 10-215322).

In a parallel system constituted by the telephone exchange apparatus and the server, a service which causes data communication connection between data terminals to cooperate with a call state of a telephone terminal to set up a video conference or the like is also strongly desired. However, in the above system, when a public network calls a telephone terminal, the telephone terminal requests a caller ID to display information related to a caller ID to the data terminal. A visual communication system which executes an additional service such as a video conference is under study and is not realized at the present.

When the visual communication system is to be realized, the following countermeasure must be studied. More specifically, functional settings of a telephone terminal and a data terminal must be matched to cause the telephone terminal and the data terminal to cooperate with each other. In this case, a user must inconveniently manually execute both the functional settings of the telephone terminal and the data terminal.

In a data communication system, a means which realizes an additional service such as notification of an operation state of a terminal executed by an audio communication system by a telephone exchange apparatus is not yet developed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram showing a visual communication system according to a first embodiment of the present invention;

FIG. 2 is a block diagram showing a functional configuration of a VCS server shown in FIG. 1;

FIG. 3 is a diagram showing an example of a storage content of a connection information management table shown in FIG. 2;

FIG. 4 is a diagram showing an example of a storage content of an extension terminal—VC associating table shown in FIG. 2;

FIG. 5 is a diagram showing an example of a storage content of a session information management table shown in FIG. 2;

FIG. 6 is a diagram showing an example of a storage content of a mapping table shown in FIG. 2;

FIG. 7 is a schematic sequence diagram showing a transmitting/receiving operation of information among an extension terminal, a main apparatus, a VCS server, and a data terminal when visual communication control is executed in the first embodiment;

FIG. 8 is a flowchart showing a control procedure of the VCS server when presence is performed to each data terminal in the first embodiment; and

FIG. 9 is a flowchart showing a control procedure of the VCS server when a functional change of a data terminal PC1 is reflected in an extension terminal T11.

### DETAILED DESCRIPTION

Various embodiments according to the invention will be described hereinafter with reference to the accompanying drawings. In general, according to one embodiment of the invention, a server apparatus which receives a call information event including a telephone ID for specifying a plurality of telephone terminals which perform call connection, and causes communication connection in a plurality of data terminals to cooperate with the call connection, the data terminals which user IDs are allocated, the data terminals which are associated with the telephone IDs, the server apparatus comprising: a memory which stores a management table in which the user IDs are caused to correspond to pieces of setting information representing functions/states of the data terminals; and a controller which updates the setting information of the corresponding first data terminal of said plurality of data terminals in the management table, in generation of an updating request of the setting information, and notifies a plurality of second data terminals different from the first data terminal of the updated setting information.

### First Embodiment

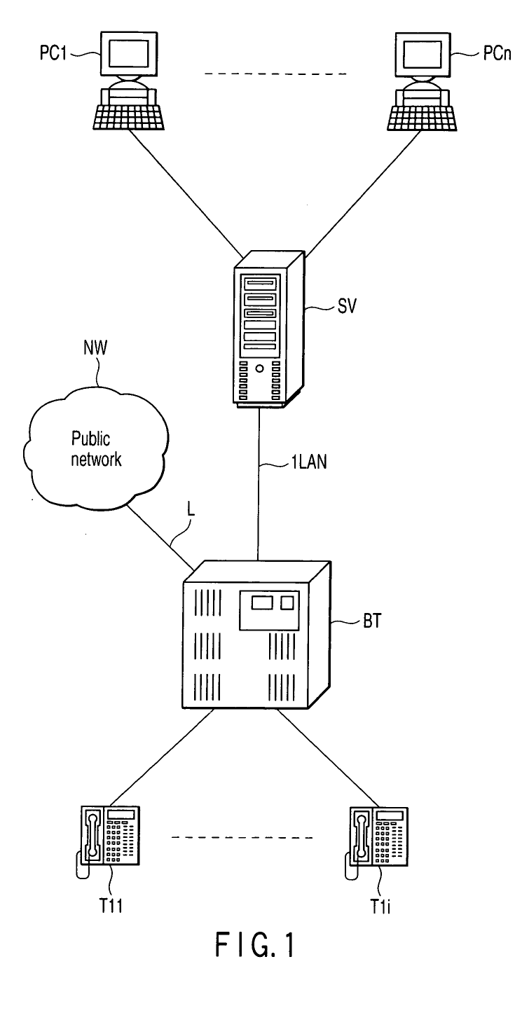

FIG. 1 is a schematic block diagram showing a visual communication system according to a first embodiment of the invention.

The system, as shown in FIG. 1, includes a main apparatus BT and a visual communication system (VCS) server SV. The main apparatus BT and the VCS server SV are connected to each other with a local area network (LAN) 1.

The main apparatus BT houses extension terminals T11 to T1i through an extension. The main apparatus BT is connected to a public network NW through a local line L. The main apparatus BT executes a switching process among the extension terminals T11 to T1i or the extension terminals T11 to T1i and the public network NW.

The VCS server SV houses a plurality of data terminals PC1 to PCn through an IP network. The data terminals PC1 to PCn are constituted by general-purpose personal computers, respectively. The data terminals PC1 to PCn operates in association with the extension terminals T11 to T1i, respectively.

The VCS server SV executes an additional function to the main apparatus BT. The VCS server SV processes media information such as a video image.

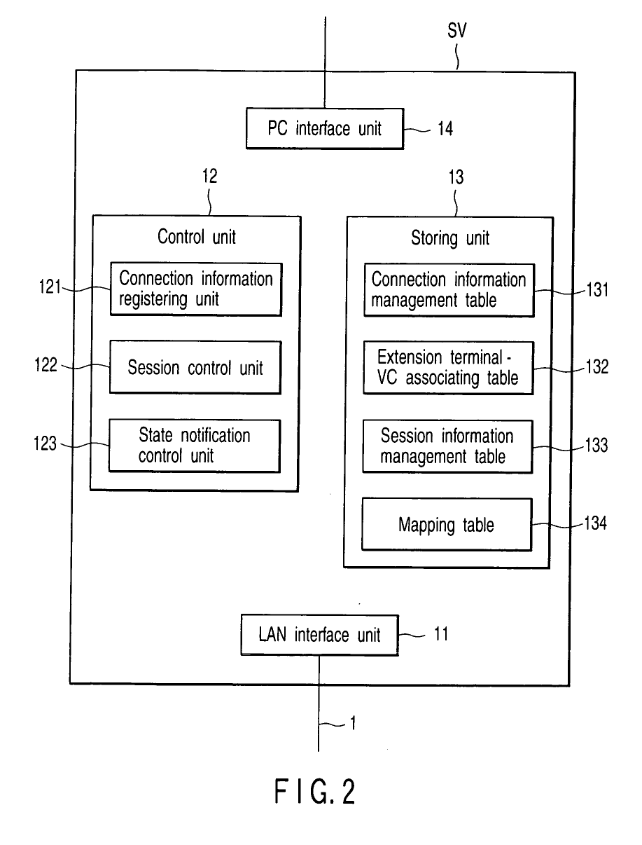

FIG. 2 is a block diagram showing a functional configuration of the VCS server SV.

The VCS server SV includes a LAN interface unit 11, a control unit 12, a storing unit 13, and a PC interface unit 14. Of these units, the LAN interface unit 11 performs an interface process to the LAN 1.

The PC interface unit 14 is to perform an interface process to the data terminals PC1 to PCn.

The storing unit 13 stores routing information or the like required for connection control to the control unit 12. Furthermore, in the storing unit 13, a connection information management table 131, an extension terminal-VC associating table 132, a session information management table 133, and a mapping table 134 are arranged.

In the connection information management table 131, as shown in FIG. 3, data expressing a corresponding relationship among the telephone numbers (telephone IDs) of the extension terminals T11 to T1i and state information showing connection states is stored. Reference symbols t1 to t9 denote the telephone IDs of extension terminals T11 to T19. Here, for descriptive convenience, the extension terminals T11 to T19 are given.

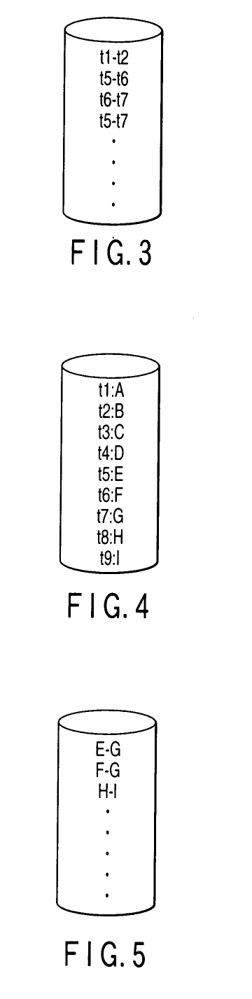

In the extension terminal-VC associating table 132, as shown in FIG. 4, a corresponding relationship among the extension terminals T11 to T1i and the data terminals (VC) PC1 to PCn is stored. Reference symbols A to I in FIG. 4 denote the user IDs of data terminals PC1 to PC9, respectively.

In the session information management table 133, as shown in FIG. 5, information expressing session states among the data terminals PC1 to PC9 is stored.

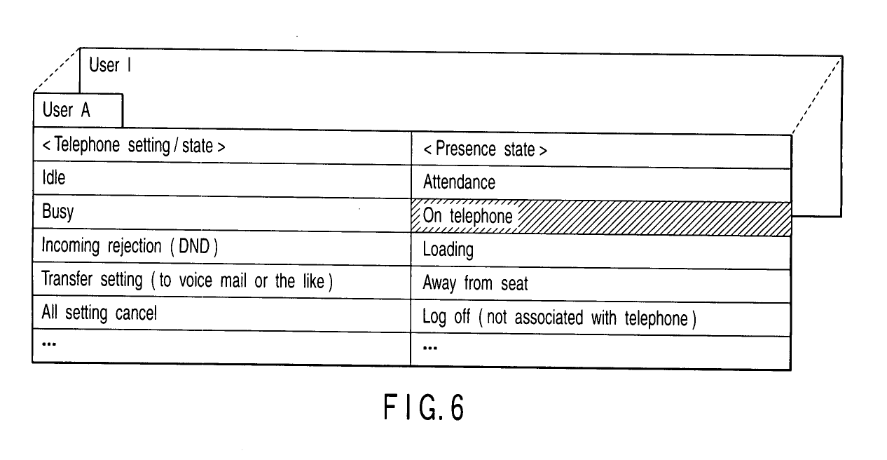

In the mapping table 134, as shown in FIG. 6, data expressing corresponding relationship among the extension terminals T11 to T19 and setting information of the presences of the data terminals PC1 to PC9 is stored. In the mapping table 134, a current presence state is represented by a hatched area in FIG. 6.

On the other hand, the control unit 12 includes, in addition to a control function related to state management of the data terminals PC1 to PCn and an associating operation among the data terminals PC1 to PCn and the extension terminals T11 to T1i, a connection information registering unit 121, a session control unit 122, and a state notification control unit 123 as new functions according to the invention.

The connection information registering unit 121 analyzes a call information event of which the main apparatus BT notifies the connection information registering unit 121 to determine that the extension terminal T15 and the extension terminal T16 are in speech communication and adds state information “t5-t6” of the connection information management table 131.

The session control unit 122 reads, based on updated state information, that the extension terminal T15 is associated with the data terminal PC5 and the extension terminal T16 is associated with the data terminal PC6 by the extension terminal-VC associating table 132. The session control unit 122 searches the session information management table 133 for session states of the data terminals PC5 and PC6. For example, when speech communication is to be started, the data terminals PC5 and PC6 do not start sessions. For this reason, the session control unit 122 controls the data terminals PC5 and PC6 to start the sessions of the data terminals PC5 and PC6. When the session control unit 122 establishes the sessions of the data terminals PC5 and PC6, the session control unit 122 updates the storage content of the session information management table 133.

When the state notification control unit 123 updates the storage content of the session information management table 133 by the session control unit 122, the state notification control unit 123 updates pieces of setting information of the data terminals PC5 and PC6 to notify the other data terminals PC1 to PC4 and PC7 to PC9 of the pieces of updated setting information.

The state notification control unit 123 has a mode which refer to the mapping table 134 and a mode which does not refers to the mapping table 134. The state notification control unit 123 selectively executes the modes depending on a setting by a user.

An operation of the visual communication system structured as described above will be described below.

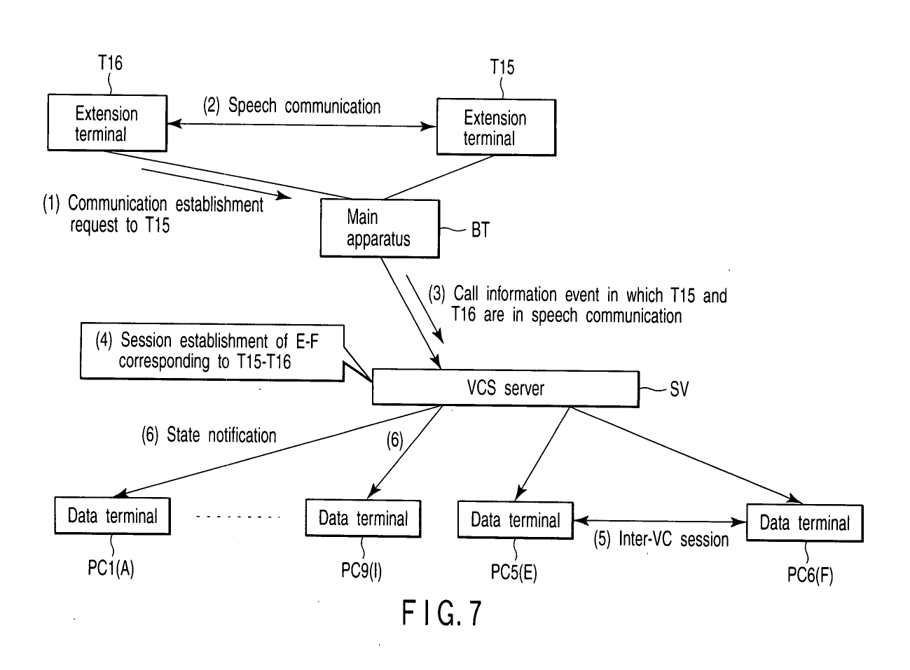

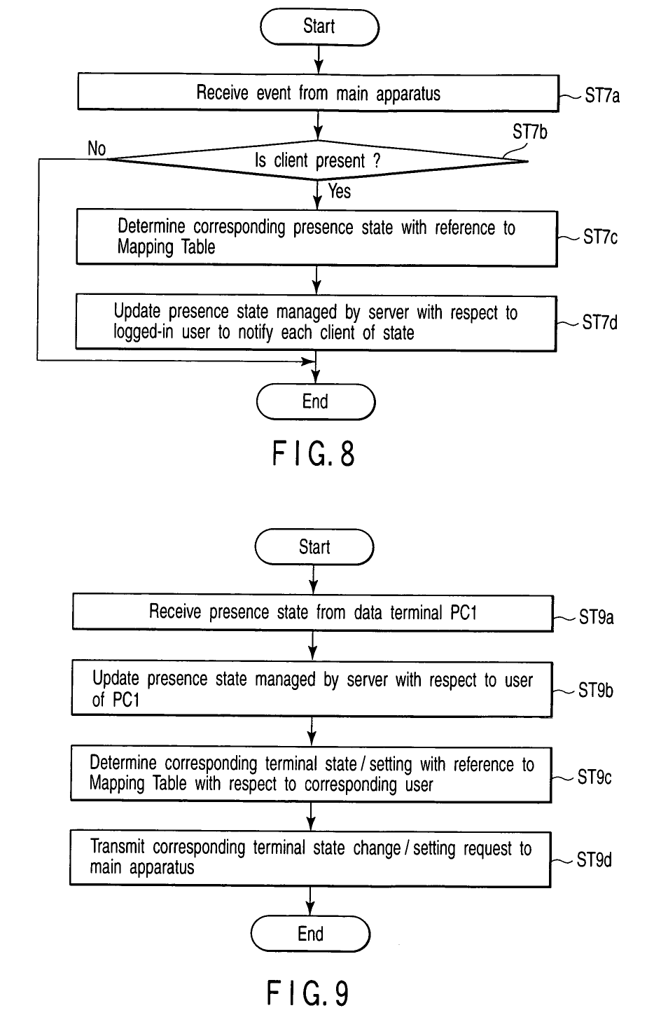

FIG. 7 is a sequence diagram showing an operation performed when presence is performed to each of the data terminals PC1 to PC9 in speech communication between the extension terminal T15 and the extension terminal T16. FIG. 8 is a flowchart showing a control processing procedure of the VCS server SV at this time.

For example, it is assumed that a user performs an operation which requests speech communication with the extension terminal T15 in the extension terminal T16 (FIG. 7(1)). In this manner, the request signal is transmitted from the extension terminal T16 to the main apparatus BT. When the main apparatus BT receives the communication establishment request signal, the main apparatus BT calls the extension terminal T15 serving as a destination. When the extension terminal T15 responds to the call, a communication link is formed between the extension terminal T15 and the extension terminal T16 (FIG. 7(2)) to transmits a call information event representing that the extension terminals T15 and the extension terminal T16 are in speech communication to the VCS server SV (FIG. 7(3)).

When the VCS server SV receives the call information event (block ST7a), the VCS server SV determines whether telephone IDs (t5 and t6) of the extension terminals T15 and T16 included in the call information event are present in the connection information management table 131. In this case, when the telephone IDs are present, the extension terminal T15 and the extension terminal T16 are stored in the connection information management table 131 in association with each other (FIG. 7(4)).

The VCS server SV refers to the extension terminal-VC associating table 132 to determine whether the data terminals PC5 and PC6 associated with the extension terminals T15 and T16 are present (block ST7b). In this case, since the data terminals PC5 and PC6 are present, the sessions of the data terminals PC5 and PC6 are established (FIG. 7(5)) to update the storage content of the session information management table 133.

Subsequently, the VCS server SV updates setting information corresponding to user IDs (E and F) of the mapping table 134 into “on the phone” (block ST7c). The VCS server SV notifies the data terminals PC1 to PC4 and PC7 to PC9 being in log-in states that the data terminals PC5 and PC6 are on the phone (block ST7d).

In block ST7b, when data terminals respectively associated with the extension terminals T15 and T16 are not present, the process is ended.

As described above, in the first embodiment, the VCS server SV has the mapping table 134 in which user IDs of the data terminals PC1 to PC9 respectively associated with the plurality of extension terminals T11 to T19 are caused to correspond to pieces of setting information showing functions/states of the data terminals PC1 to PC9. By using the call information event of which the main apparatus BT notifies the VCS server SV, the VCS server SV updates the pieces of setting information of the corresponding data terminals PC5 and PC6 of the mapping table 134 to notify the other data terminals PC1 to PC4 and PC7 to PC9 of the updated setting information.

Therefore, each time the presence states of the data terminals PC5 and PC6 are changed, the VCS server SV can notify the data terminals PC1 to PC4 and PC7 to PC9 of the changes of the presence states of the data terminals PC5 and PC6 with reference to the mapping table 134.

A user may register the pieces of setting information of the data terminals PC1 to PC9 in the mapping table 134 only once. For this reason, the setting functions of the extension terminals T15 and T16 and the data terminals PC5 and PC6 to be caused to cooperate with each other can be matched with each other by a simple procedure. In this manner, inconsistent settings/states can be avoided. For example, a telephone call can be prevented from being received even though absence is set in the presence state. Both the functional settings of the extension terminals T15 and T16 and both the functional settings of the data terminals PC5 and PC6 need not be independently operated. As a result, the convenience for the user is considerably improved.

In the first embodiment, modes are set in units of the data terminals PC1 to PC9 or the setting functions to update the setting information of the corresponding data terminal PC1 in the mapping table 134 each time the data terminal PC1 is notified of call information event by the main apparatus BT and notify the other data terminals PC2 to PC9 of the updated setting information. On the other hand, each time the main apparatus BT notifies the other data terminal PC2 of a call information event, the other data terminals PC1 and PC3 to PC9 are notified of the function information updated by the data terminal PC2 without referring to the mapping table 134, so that the data terminals PC1 to PC9 can also be notified of optimum presence states, respectively. For each presence such as “incoming rejection”, it can be determined whether the mapping table 134 is used.

### Second Embodiment

FIG. 9 is a flowchart showing, as a second embodiment of the invention, a control procedure of a VCS server SV when a change in setting of the data terminal PC1 is reflected in the extension terminal T11.

For example, it is assumed that a user sets “away from seat” in the data terminal PC1. In this case, the change message is transmitted from the data terminal PC1 to the VCS server SV.

When the VCS server SV receives the change message from the data terminal PC1 (block ST9a), with respect to a user ID(A) of the data terminal PC1 in the mapping table 134, the presence state is adapted from “attendance” to “away from seat” (block ST9b). In this case, the data terminals PC2 to PC9 are notified of the states.

The VCS server SV determines a corresponding terminal state/setting based on the presence state with reference to the mapping table 134 (block ST9c) and transmits a corresponding terminal setting change/setting request to the main apparatus BT (block ST9d). In this case, an incoming rejection setting request, Call Forward setting request, and the like are given as examples. When other settings are established yet, a request for canceling the settings is also transmitted as needed.

The main apparatus BT receives a request from the VCS server SV and performs a corresponding terminal state change/setting request. In this case, the setting of the extension terminal T11 associated with the data terminal PC1 is changed from “idle” to “transfer to voice mail”.

As described above, according to the second embodiment, by using the mapping table 134, when a user performs only changes in setting of the presence states of the data terminals PC1 to PC9, a change in function/state of the extension terminal T11 associated with the data terminal PC1 can be automatically performed. In this manner, inconsistent settings/states can be avoided. For example, a telephone call can be prevented from being received even though absence is set in the presence state. Both the functional settings of the extension terminals T15 and T16 and the functional settings of the data terminals PC5 and PC6 need not be independently operated. As a result, the convenience for the user is considerably improved.

Also in the second embodiment, as in the first embodiment, for each of the data terminals PC1 to PC9 or the presence states thereof, it can be determined whether the mapping table 134 is referred to.

### Other Embodiment

The invention is not limited to the above embodiments. For example, the first embodiment exemplifies that the mapping table is updated by using the call information event from the main apparatus. However, the invention is not limited to the embodiment, the content of the mapping table is changed from a maintenance terminal connected to the VCS server, or the table may be updated from a data terminal through a means such as a hyper text transport protocol (HTTP).

Each of the embodiments exemplifies that the main apparatus and the VCS server are independently arranged. However, the functions of the main apparatus may be incorporated in the VCS server.

In addition, the configuration and the type of the VCS server, the type of the telephone switching devices (not only the main apparatus but also a PBX may be used), the type of the extension terminal, the type of the data terminal, the storage contents of the various tables, the session control method between the data terminals, the presence changing method, and the like can be variously changed and modified without departing from the spirit and scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives a call information event including a telephone ID for specifying a plurality of telephone terminals which perform call connection, and causes communication connection in a plurality of data terminals to cooperate with the call connection, the data terminals which user IDs are allocated, the data terminals which are associated with the telephone IDs, the server apparatus comprising:
a memory which stores a management table in which the user IDs are caused to correspond to pieces of setting information representing functions/states of the data terminals; and
a controller which updates the setting information of the corresponding first data terminal of said plurality of data terminals in the management table, in generation of an updating request of the setting information, and notifies a plurality of second data terminals different from the first data terminal of the updated setting information.

2. The server apparatus according to claim 1, comprising:
an interface which connects a telephone exchange apparatus which executes a switching process among said plurality of telephone terminals, and receives the call information event transmitted the telephone exchange apparatus,
wherein the controller refers to the management table based on the telephone ID and information representing a function/state of a telephone terminal corresponding to the telephone ID, and updates setting information of the first data terminal associated with the telephone ID based on the reference result.

3. The server apparatus according to claim 2, wherein the controller refers to the management table based on the setting information of the first data terminal and notifies the telephone exchange apparatus of designation information to change a function/setting to a telephone terminal associated with the first data terminal based on the reference result.

4. The server apparatus according to claim 2, wherein the controller comprises:
a first mode which refers to the management table based on the telephone ID and information representing a function/state of a telephone terminal corresponding to the telephone ID, updates setting information of the first data terminal associated with the telephone ID based on the reference result and notifies the plurality of second data terminals of the updated setting information;
a second mode which notifies the plurality of second data terminals of the updated setting information of the first data terminal associated with the telephone ID based on the telephone ID and information representing the function/state of the telephone terminal corresponding to the telephone ID; and
a mode controller which selectively executes the first and second modes depending on a mode designating operation.

5. The server apparatus according to claim 3, wherein the controller comprises:
a first mode which refers to the management table based on the setting information of the first data terminal and notifies the telephone exchange apparatus of designation information to change a function/setting to a telephone terminal associated with the first data terminal based on the reference result;
a second mode which notifies the telephone exchange of designation information to change the function/state to the telephone terminal associated with the first data terminal based on the setting information of the first data terminal; and
a mode controller which selectively executes the first and second modes depending on a mode designating operation.
